(19) United States
(12) Patent Application Publication
(10) Pub. No.: US 2025/0315089 A1
(43) Pub. Date: Oct. 9, 2025

(54) SYSTEMS AND METHODS FOR MONITORING DEVICE NON-USAGE

(71) Applicants: Matthew Jarman, Salt Lake City, UT (US); Belliston Ethan, Provo, UT (US); Eric Barker, Provo, UT (US); Karl Knapp, Pleasant Grove, UT (US)

(72) Inventors: Matthew Jarman, Salt Lake City, UT (US); Belliston Ethan, Provo, UT (US); Eric Barker, Provo, UT (US); Karl Knapp, Pleasant Grove, UT (US)

(21) Appl. No.: 18/627,781

(22) Filed: Apr. 5, 2024

Related U.S. Application Data
(60) Provisional application No. 63/457,388, filed on Apr. 5, 2023.

(51) Int. Cl. G06F 1/28; H02J 7/00

(52) U.S. Cl. CPC G06F 1/28; H02J 7/00034; H02J 7/0045; H02J 7/0047

(57) ABSTRACT

Systems and methods for monitoring non-use of personal electronic devices are disclosed. Connection of a personal electronic device to a charging circuit is detected and identified to a particular personal electronic device. Electrical charging and physical presence of the personal electronic device are identified. Electrical connections and physical presence of each personal electronic device can be aggregated or otherwise considered in combination and rendered to a display to provide feedback and gamification of periods of non-use of the personal electronic devices. Gamification can be employed to promote non-use of the personal electronic devices.

### TECHNICAL FIELD

The present disclosure relates generally to monitoring of personal portable electronic computing devices, and more specifically, to monitoring non-usage of one or more individual personal portable electronic computing devices for each of one or more individuals.

### BACKGROUND

Proliferation of personal electronic devices (e.g., Internet-connected “smartphones,” tablet computers, etc.) and applications on those devices has created a problem where people are spending an ever-increasing amount of time in the digital world and not enough time (or consistently less and less time) outside the digital world. A Netflix documentary, The Social Dilemma (Orlowski, J. (Director). (2020). [Film] Netflix), details how applications on personal electronic devices are designed to attract and hold the users attention for extended periods of time. As a user's time dedication to these applications increases, real world productivity of the user (of any age) may radically decrease, leading to an adverse impact on the user's educational experience, work opportunities, quality of life, etc. Furthermore, reducing, even by a relatively small amount, usage of a smartphone can have a marked improvement on one's mental health. (“A Small Reduction in Smartphone Use Can Make a Big Difference for Mental Health,” Flemming, L., Verywell Mind. https://www.verywellmind.com/reducing-smartphone-use-can-improve-mental-health-5271918 (2022) (last accessed Mar. 26, 2024).)

### SUMMARY

The present disclosure provides inducement for an individual or motivation to advantageously reduce time spent using a personal electronic computing device to enable an increase in time involved in real world activities. The present disclosure can provide for “gamification” whereby a group of individuals, e.g., a family, may improve their real-world experiences by competing to create meaningful reductions in time spent in the digital realm of personal electronic computing devices.

Additional aspects and advantages will be apparent from the following detailed description of preferred embodiments, which proceeds with reference to the accompanying drawings.

### BRIEF DESCRIPTION OF THE DRAWINGS

FIG. 1 is a system diagram of a presently available system for charging a personal electronic device.

FIG. 2A is a system diagram for a non-use monitoring system (NuMS), according to an embodiment of the present disclosure.

FIG. 2B is a system diagram of the NuMS of FIG. 2A having a plurality of devices.

FIG. 3A is a system diagram of a NuMS that is similar in at least some respects to the NuMS of FIGS. 2A and 2B having a tabulation display.

FIG. 3B is a system diagram of the NuMS of FIG. 3A displaying an output reflecting a tabulation of non-use of each of a pair of devices.

FIG. 4 is diagram of a detector for a NuMS, according to an embodiment of the present disclosure.

FIG. 5 is a system diagram of a NuMS, according to an embodiment of the present disclosure, and comprising a charging station and a plurality of remote components.

FIG. 6 is a partial front view of a charging station of a NuMS, according to an embodiment of the present disclosure, and illustrating operation of a pressure plate.

FIG. 7A is a partial top view of a charging station of a NuMS, according to an embodiment of the present disclosure, and illustrating various user interface methods.

FIG. 7B is a partial top view of a charging station of a NuMS, according to an embodiment of the present disclosure, and illustrating various user interface methods.

FIG. 8 is a method for operation of NuMS, according to an embodiment of the present disclosure.

FIG. 9 diagrams an architecture of a NuMS, for use in monitoring, tabulating, reporting, and gamifying non-use of personal electronic devices, according to an embodiment of the present disclosure.

### DETAILED DESCRIPTION OF PREFERRED EMBODIMENTS

The embodiments disclosed herein provide incentive for individual users of a plurality individual users of personal electronic devices to put the device down and be rewarded for time not spent on the personal electronic device. Said otherwise, the individual user is motivated to reduce time spent using the individual user's personal electronic device(s) through a means of gamification among a plurality of individual users.

As used herein, “personal electronic device” (device) refers to a handheld personal computing device, such as, e.g., an Internet-capable telephone (smartphone), a tablet computing device (tablet), a mobile computing device, such as, e.g., a laptop, an electronic gaming device, etc.

As used herein, “coupled” refers to a physical or electrical connection between two or more components. A physical connection may comprise two or more components physically touching or being in proximity to each other, or being interconnected as by another component. An electrical connection is any connection whereby electrical power or an electrical signal is permitted or caused to flow from one component to one or more other components.

As used herein, the terms “tabulate” and “aggregate” refer to mathematically processing data to produce a datum or data. In other words, tabulate and aggregate each refers to quantifying a plurality of values to a value, such as, e.g., additively, multiplicatively, derivatively, etc. The terms tabulate and aggregate may be used interchangeably in the present disclosure without conferring disparate meaning.

As used herein, the term “connection tabulator” refers to either a set of operative computer-readable instructions whereby tabulation is performed, or to a human-readable visual rendering (as at a display) of a result of the aforementioned tabulation. The particular meaning of the phrase will be apparent to one having ordinary skill in the art.

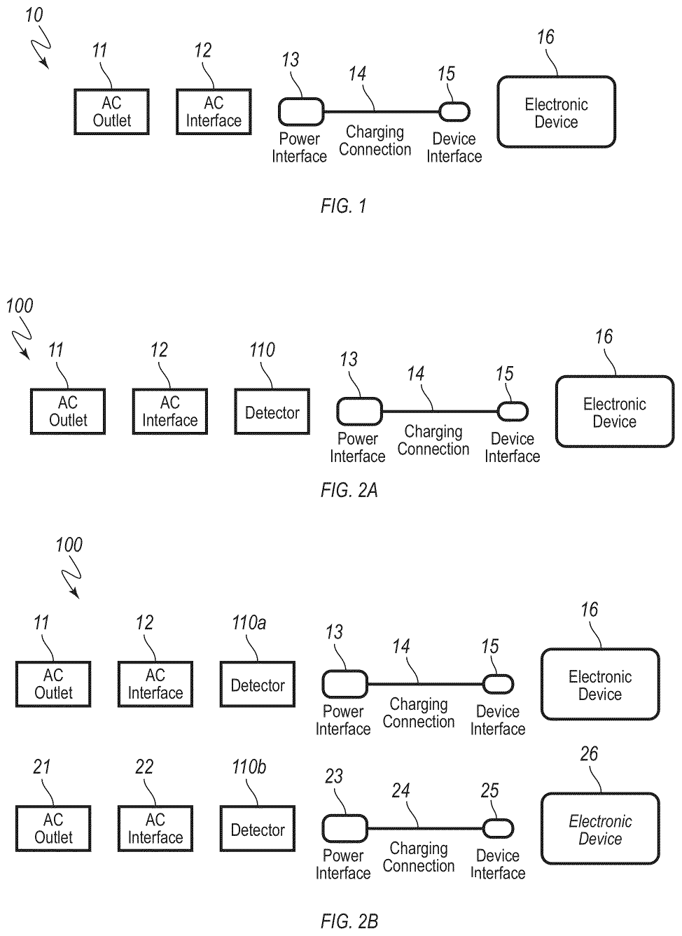

FIG. 1 is a system diagram of a presently available system 10 for charging a personal electronic device (device) 16. The system 10 comprises an alternating current (AC) outlet 11, an AC interface 12, a power interface 13, a charging connection 14, a device interface 15, and the device 16. The AC outlet 11 may be an electrical box capable of providing AC power to a power consuming item. The AC interface 12 may be connectable interface (e.g., an electrical plug) permitting electrical coupling, for example, of a power cord of a device or appliance to the AC outlet 11. The power interface 13 may be a component that electrically couples a power-consuming item to the AC interface 12 and may alter the electrical power received from the AC interface 12. In the present example, the power interface 13 may be a charger for the device 16 which converts AC power to direct current (DC) power at a particular amperage for the device 16. The charging connection 14 represents a conduit whereby power, e.g., DC power, is provided from the power interface 13 to the device interface. The charging connection 14 may be wired or wireless. The device interface 15 may be a connector serving to electrically couple the charging connection 14 to the device 16 whereby electrical power is delivered to the device. The device interface 15 may be any appropriate or device-specific plug-type connection (e.g., a universal serial bus (USB) connector, etc.) or a wireless charging solution (e.g., an inductive charging puck, etc.). The device 16 may be a personal electronic device, such as, for example, a smartphone (e.g., an Apple iPhone®, a Samsung Galaxy®, etc.), a tablet computer (e.g., an Apple iPad®, a Samsung Galaxy Tab®, an Amazon Kindle®, etc.), a mobile computing device, such as, e.g., a laptop, a handheld electronic gaming device (e.g., a Nintendo Switch®, a Nintendo Switch Lite®, etc.), etc.

FIG. 2A is a system diagram for a non-use monitoring system (NuMS) 100 for a device, according to an embodiment of the present disclosure. The AC outlet 11, the AC interface 12, the power interface 13, the charging connection 14, and the device interface 15 are shown for reference. A detector 110 is disposed between the AC interface 12 and the power interface 13. The detector 110 is electrically coupled to the AC interface 12 and the power interface 13. The detector 110 provides an electrical coupling between the AC interface 12 and the power interface 13. More generally stated, the detector 110 is electrically coupled, via the power interface 13, et seq., between the device 16 and the AC interface 12. The detector 110 is configured to detect when the device 16 is electrically coupled to the detector 110. In one embodiment, the detector 110 may detect that a current is drawn as a result of the device 16 being electrically coupled at the device interface 15. In one embodiment, the detector may comprise a shunt resister current sensor. In one embodiment, the detector 110 may comprise a specialized integrated circuit chip such as, e.g., a hall effect sensor chip. The detector 110 may detect when a device 16 from a variety of manufacturers is electrically coupled to the NuMS 100. The detector 110 may be particularly configured to determine when the device 16 is in a normal charging state or when the device 16 is in a low-charge or trickle charge state (such as, e.g., for battery conditioning, “smart” charging, etc.). The detector 110 may identify discrete charging current changes, such as timed changes between 10 mA and 100 mA is typically occurs while trickle charging. When the detector 110 detects that the device 16 is electrically coupled, the detector 110 may generate a signal that the device 16 is electrically coupled. This signal can then be used as a means of measuring when and how long the device 16 is electrically coupled to the detector 110. The duration that the device 16 is electrically coupled to the detector 110 may be indicative of a period of non-use of the device by a user. The detector 110 may be configured to transmit the signal indicating that the device 16 is electrically coupled to the detector 110 to a component capable of manipulating data of the signal and/or displaying data regarding the coupling of the device 16 to the detector 110. In one embodiment, the signal may be transmitted to the device 16.

By way of non-limiting example, in a home a parent may want to know that a particular device is at a particular location of the home. By placing the detector 110, the power interface 13, et seq., at an AC interface 12 at the desired location, the parent can be informed by the NuMS 100 of times and durations that the device is electrically coupled at the location.

Attributes of the connection of the electrical coupling may help identify the device based on information that is communicated through the various components (the device interface 15, the charging connection 14, the power interface 13, etc.). For example, a device might be identified by a current draw through the electrical coupling. To the extent that data is communicated through the connection of the electrical coupling, this data could also be available to identify the device 16 that has been electrically coupled.

FIG. 2B is a system diagram of the NuMS 100 of FIG. 2A, according to an embodiment of the present disclosure, and including monitoring for a plurality of devices 16, 26. The AC outlet 11, the AC interface 12, a detector 110a, the power interface 13, the charging connection 14, the device interface 15, and the device 16 are shown for reference. A second AC outlet 21, a second AC interface 22, a second detector 110b, a second power interface 23, a second charging connection 24, a second device interface 25, and a second device 26 are also shown. In one embodiment, the AC interface 12 and the second AC interface 22 may both employ the AC outlet 11. In an environment where there are multiple devices and multiple charging connections, uniquely identifiable components could be associated with the different charging connections (electrical couplings). In the embodiment of FIG. 2B, the detector 110b is uniquely identifiable from the detector 110a. To extend the former example, the parent may associate a child with detector 110a and the parent with detector 110b. When the child connects the device 16 to the device interface 15 associated to the detector 110a, the connection can be attributed to the device 16 of the child.

When a device 16, 26 is coupled to a detector 110a, 110b, respectively, the connection information can be communicated to a component that tabulates information about that connection. In one embodiment, the component that tabulates information about the connection may be a device 16, 26. This communication can be achieved through a wired or wireless connection. The tabulation can tabulate various attributes about the connection. The tabulation may comprise a time of day the connection was made, how long the connection was made, the date the connection was made, and any other attributes that may be available through or derivable from either power or data that flows through the connection. The tabulation may comprise adding together durations of multiple connections (e.g., instances of connection) of the particular device 16, 26 to produce a total duration of connection. Various calculations meaningful in the context of promoting non-use of the device 16, 26 are anticipated by the present disclosure.

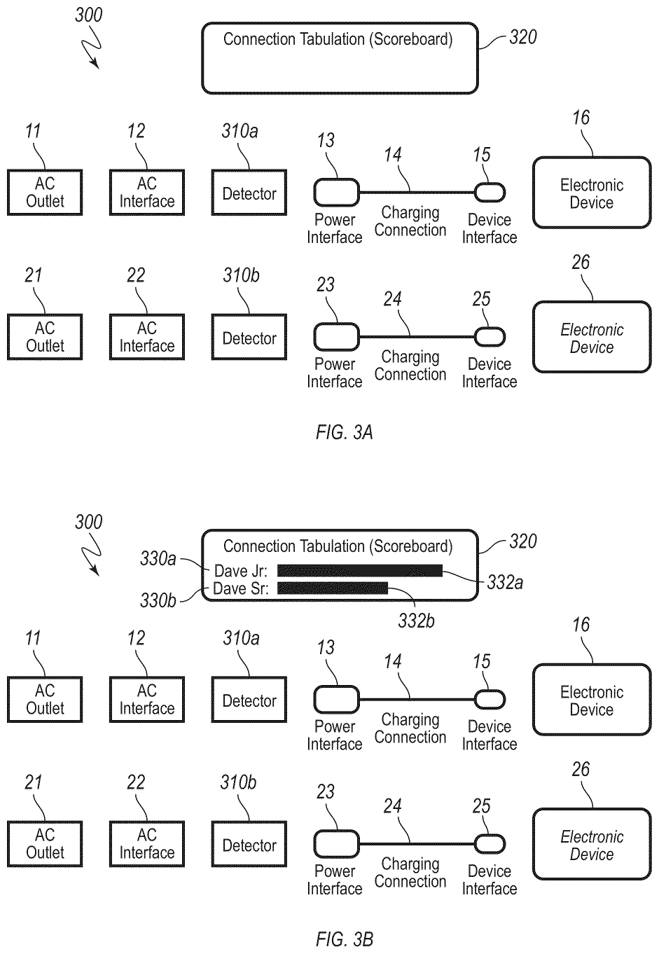

FIGS. 3A and 3B depict an embodiment of a non-use monitoring system (NuMS) 300, according to an embodiment of the present disclosure. The NuMS 300 may resemble the NuMS 100 described above with reference to FIGS. 2A and 2B in some respects. Accordingly, like features are designated with like reference numerals, with the leading digit incremented to “3.” For example, the embodiment depicted in FIGS. 3A and 3B includes a detector 310a and a detector 310b which may, in some respects, resemble the detector 110 of FIG. 2A and the detector 110a and the detector 110b of FIG. 2B. Relevant disclosure set forth above regarding similarly identified features thus may not be repeated hereafter. Moreover, specific features of the NuMS 300 and related components shown in FIGS. 3A and 3B may not be shown or identified by a reference numeral in the drawings or specifically discussed in the written description that follows. However, such features may clearly be the same, or substantially the same, as features depicted in other embodiments and/or described with respect to such embodiments. Accordingly, the relevant description of such features applies equally to the features of the NuMS 300 and related components depicted in FIGS. 2A and 2B. Any suitable combination of features, and variation of the same, described with respect to the NuMS 100 and related components illustrated in FIGS. 2A and 2B can be employed with the NuMS 300 and related components of FIGS. 2A and 2B, and vice versa.

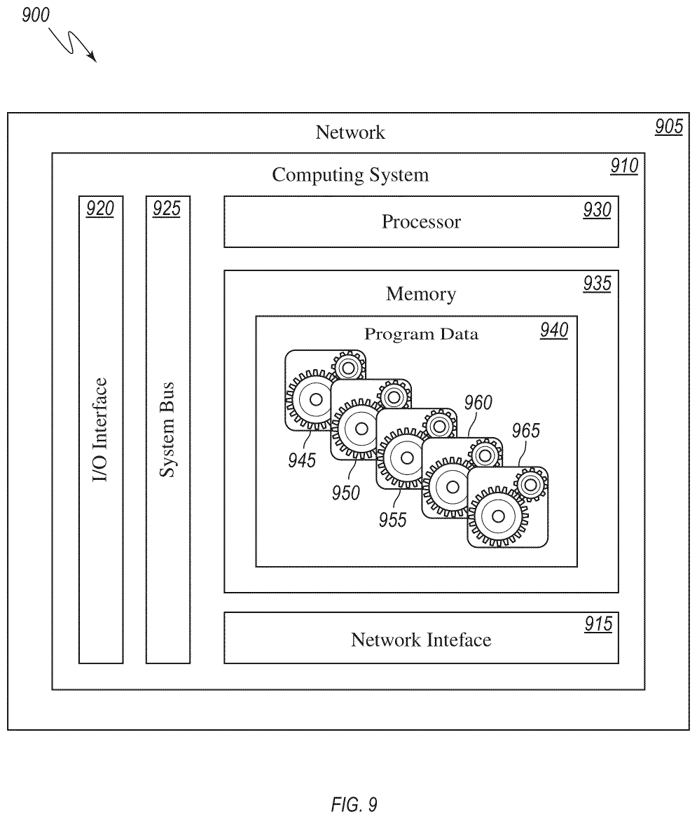

FIG. 3A is a system diagram of the NuMS 300 that is similar in at least some respects to the NuMS 100 of FIGS. 2A and 2B, according to an embodiment of the present disclosure, and having a tabulation display 320. The AC outlets 11, 21, the AC interfaces 12, 22, the detectors 310a, 310b, the power interfaces 13, 23, the charging connections 14, 24, the device interfaces 15, 25, and the devices 16, 26 are shown for reference. The detectors 310a, 310b may send a signal to a tabulation engine each time a connection change is detected, such as, e.g., when the device 16, 26 is electrically couped/decoupled (see the tabulation engine 965 in FIG. 9). The tabulation engine may, in turn, send a signal to the tabulation display 320 to update displayed information. The detectors 310a, 310b may send a signal each time a connection is detected, at particular intervals to indicate a connection status, when the detectors, 310a, 310b detect the device 16, 26 is disconnected, and at other times or upon other triggering events. The detectors 310a, 310b can also monitor whether additional power draw or data indicators indicate whether the device 16, 26 is inactive or in use (e.g., the device 16, 26 is being used while connected to the detector 310a 310b). Depending on indication of the device active state, points to the tabulator could be additionally regulated. For example, if the device 16, 26 is connected to the detector but is also being used, points for non-use may not be awarded, or only partial points be awarded. The tabulation display 320 may tabulate or aggregate data regarding each connection of the devices 16, 26, such as, e.g., day, date, time, duration of connection, etc. The tabulation of the information sent to the tabulation display 320 can be aggregated and displayed in a manner that provides user meaningful feedback.

FIG. 3B is a system diagram of the NuMS 300 of FIG. 3A, according to an embodiment of the present disclosure, and displaying an output reflecting non-use of the devices 16, 26. The AC outlets 11, 21, the AC interfaces 12, 22, the detectors 310a, 310b, the power interfaces 13, 23, the charging connections 14, 24, the device interfaces 15, 25, and the devices 16, 26 are shown for reference. The calculation tabulator 320 is shown rendering a visual representation of the aggregation (tabulation) 332a, 332b of connections for the devices 16, 26. More particularly, the calculation tabulator 320 reflects connections of the devices 16, 26 to a detector, such as the detectors 310a, 310b. The tabulation or aggregation 332a, 332b for each device 16, 26 has an associated label 330a, 330b to relate each tabulation or aggregation 332a, 332b to the respective device 16, 26 and, hence, to the respective user. The labels 330a, 330b may be customizable, such as, to show the name of the user of the particular device. Said otherwise, the NuMS 300 further comprises an identity indicator to indicate an identity of, or identity of an individual associated with, the personal electronic device 16, 26. For example a child (Dave Jr, the label 330a) and parent (Dave Sr, the label 330b) could have a competition about who can have their respective device in the connection for the longest cumulative duration. In one embodiment, on support of the gamification of non-use of personal electronic devices, the NuMS 300 may enable each user to select a label 330a, 330b from a collection of well-known personalities (real or fictional), popular culture, etc. (hereafter, fandom collection). By way of non-limiting examples, a fandom collection may include characters from the DC universe (e.g., Batman, Flash, Superman, Wonder Woman, etc.), the Star Wars universe (e.g., Chewie, Han, Leia, Luke, etc.), the Marvel Avengers sphere (e.g., Hawkeye, Ironman, Nick, Phil, Thor, etc.), the Marvel Guardians of the Galaxy sphere (Drax, Gamora, Groot, Peter, Rocket, etc.), names of actors portraying roles, names of royalty, sports figures, and other celebrities, etc. The person whose device is connected the longest (in a single connection, or in aggregate) can win an agreed reward. The calculation tabulator 320 may comprise a logical scoreboard that can be displayed on an electronic device, such as a wireless digital picture frame (frame), a tablet, a computer, a phone, a device of one or more of the users, etc. For example, a user could place the frame on a counter top, wall, etc. A scoreboard image could also be displayed on a website, in an application of a device, etc. It should be noted that reference to two users and two devices 16, 26 is for convenience of the disclosure and not by way of limitation. The present disclosure anticipates that more than two users and more than two devices 16, 26 may be used with the NuMS 300.

There are multiple types of tabulation attributes that can be used to help achieve a desired result for the plurality of users (such as for a family). For example, each individual whose device 16, 26 is connected at a particular time of day may receive additional “points” on the scoreboard. In a family setting, the family may have a goal to connect each device 16, 26 at 9 pm, and a device 16, 26 connected earlier than 9 pm may receive additional “tabulation points.” The family may have a combined goal that is cumulative across multiple connections, e.g., to have a cumulative connection time of 10,000 hours to go on a trip.

There can be gamification elements of tabulation. For example, the first person to connect their device 16, 26 after 3 pm receives additional points or a specific reward. Points could be subtracted from a person for disconnecting his/her device 16, 26 for an extended period of time, or during a designated non-use connection period (e.g., during designated overnight hours). In a head-to-head competition, points could be added to a first person if a second person disconnects their device 16, 26. Points could be added to a person for continuing a particular streak for a period of time (e.g., the user keeps his/her device 16, 26 connected for a minimum number of hours for a minimum range of consecutive days). Notification can be sent to everyone when a member of the group connects and/or disconnects a device 16, 26. Users can issue challenges to each other. By way of example, a first user challenges a second user to connect a device 16, 26 plugged within the next five minutes, to receive an award of bonus points. The NuMS 300 by be configurable such that, randomly during a day, messages could be sent out to all the users of the NuMS 300 that whoever gets a device 16, 26 connected first in the next five minutes gets extra bonus points, or failure to connect a device 16, 26 in the declared time frame results in losing a number of points. A point algorithm could detect when a certain percentage of users' devices 16, 26 are connected, and give them all additional “team” bonus points. For example if 70% of the users have their devices 16, 26 connected, each user who is part of that 70% gets a number of bonus points. Furthermore, those whose devices 16, 26 are not connected could lose points for not being connected while a threshold of other users are connected. For those not connected, points could be subtracted over time until they connect their device 16, 26, and when they do connect their device 16, 26, all users in the group could receive a combined bonus. There could be combined bonuses when all users' devices 16, 26 are connected at the same time. For example, if all family member-users' devices 16, 26 are connected at 5 pm, they all get additional points, and/or if they all stay connected for a particular length of time, they all get an allotment of bonus points. Devices and/or people can be grouped into competitive teams. The connection behaviors of team members can then be measured and tabulated in competitive manners. For example, one school of students might compete with a different school of students to accomplish a desired combined score where the winning team achieves an agreed award, for example a discounted rate at a community retailer. These are various examples of rewarding and incentivizing behaviors based on tracking connections, connection times, and comparing that information with that of other users and their connection attributes.

Points may be tabulated or aggregated by the tabulation display 320, by the device 16, 26 of an administrator for the NuMS 300, etc. Points may be displayable with or in place of other visual components of the display. Various goal achievements in the tabulator might unlock electronic rewards. For example, as soon as a user (e.g., a child) has obtained a specific connection goal a particular application on his/her device 16, 26 may become available.

The NuMS 300, or the tabulation display 320 can exist in a closed development environment, where a single provider of “tabulation” interfaces and incentives develops the software to aggregate and/or visualize the tabulation. The NuMS 300, or the tabulation display 320 can also exist in an open environment, where multiple providers of “tabulation” interfaces and incentives can provide their own tabulation environments. These providers may have a monetization model where their tabulators are available in a tabulator marketplace.

In one embodiment, the tabulation display 320 may be an analog counting device. For example, the tabulation display 320 may comprise a rotary number system that increments based on connections of the component. In one embodiment, the tabulation display 320 may be an electronic device such as a tablet on which various tabulation software(s) can be installed and made available to the end-user.

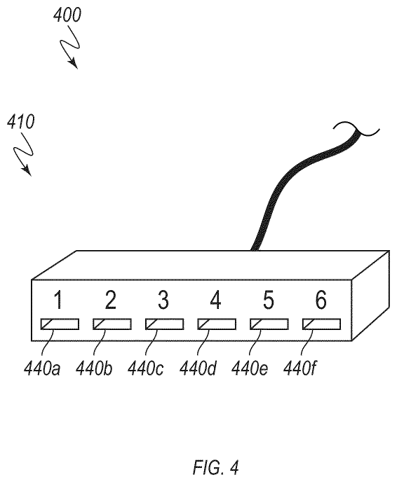

FIG. 4 is diagram of a detector 410 for a NuMS 400, which is similar in at least some respects to the NuMS 100, 300 of FIGS. 2A-3B, according to an embodiment of the present disclosure. While the NuMS 200, 300 of FIGS. 2A-3B are illustrated as having a detector 110, 110a, 110b, 310a, 310b for each respective device each coupled to disparate AC interface 12, 22, this is for convenience of the disclosure and not by way of limitation (see the device 16, 26 in FIGS. 2A-3B). A detector 410 for a NuMS 400 may comprise multiple detector circuits in a unitized housing. In one embodiment, the detector 410 may comprise a software or firmware component that is capable of distinctly identifying each device connected to the detector 410 and a member of a pool of devices assigned within the NuMS 400. Said otherwise, the NuMS 400 comprises a first detector to detect an electrical coupling of the personal electronic device to an electrical charging circuit. In one embodiment, the first detector may comprise a shunt resistor current sensor. In one embodiment, the first detector may comprise a hall effect sensor chip. In the example of FIG. 4, the detector 410 is shown having six ports 440a-440f. Each of the ports 440a-440f may have a dedicated detector circuit, or subsystem, configured to detect a connection of a device, such as the devices 16, 26. The detector 410 may be configured to associate particular characteristics of an electrical coupling to a particular device. In other words, the detector 410 may be configured to discriminate between connections of each device that may coupled to the detector 410. In one embodiment, each port 440a-440f may be assigned to a particular device such that when a device is connected to a port 440a-440f, the connection is related to the assigned device (and, hence, associated to the relevant user), regardless of what device is actually coupled at the particular port 440a-440f. By way of example, if the port 440a is assigned to the device of a particular child, and device connected to port 440a may be credited as a connection of the device of the particular child. In one embodiment, the detector 410 may be configured to identify a connection from a particular device regardless of to which of the ports 440a-440f a particular device is connected. In other words, a connection of a particular device may be related to that particular device regardless of the port 440a-440f to which the device is connected. The illustration of six ports 440a-440f is for convenience of the disclosure and not a limitation. The present disclosure anticipates that the detector 410 may have more or fewer ports 440a-440f. In one embodiment, the detector 410 may comprise a different connection hardware than a port, such as, e.g., a power outlet, an inductive charging puck, etc. In one embodiment, the detector 410 may be configured to receive, at one of the ports 440a-440f, a connection from another detector 410. In one embodiment, the detector 410 may comprise a capability to perform at least a portion of data tabulation or aggregation. In one embodiment, the detector 410 may further comprise a display to render a visible output of the aggregation or tabulation. Identification of a particular device may be done by measuring unique characteristics of the power consumption and/or other electrically distinct characteristics (a so-called “fingerprint”) of the particular device. The tabulation display may be configured or configurable to permit assignment or association of connection time to a particular device charging signature (see the tabulation display 320 in FIG. 2B). For example, unique characteristics of the power draw could be used to uniquely identify devices. These unique characteristics could then be matched to a database of device signatures (for example if a signature matches an Apple iPad®, then assign tabulation to “iPad” (or to a media access controller identifier (MAC ID) for the particular device, etc.). In one embodiment, users (or an administrative user) may be able to manually create user friendly labels, e.g., “Mom's iPad,” “Mom's phone,” etc. These labels may be associated to an identifiable and unique “fingerprint” or other data that are measurable for the device (for example, e.g., unique power draw characteristics).

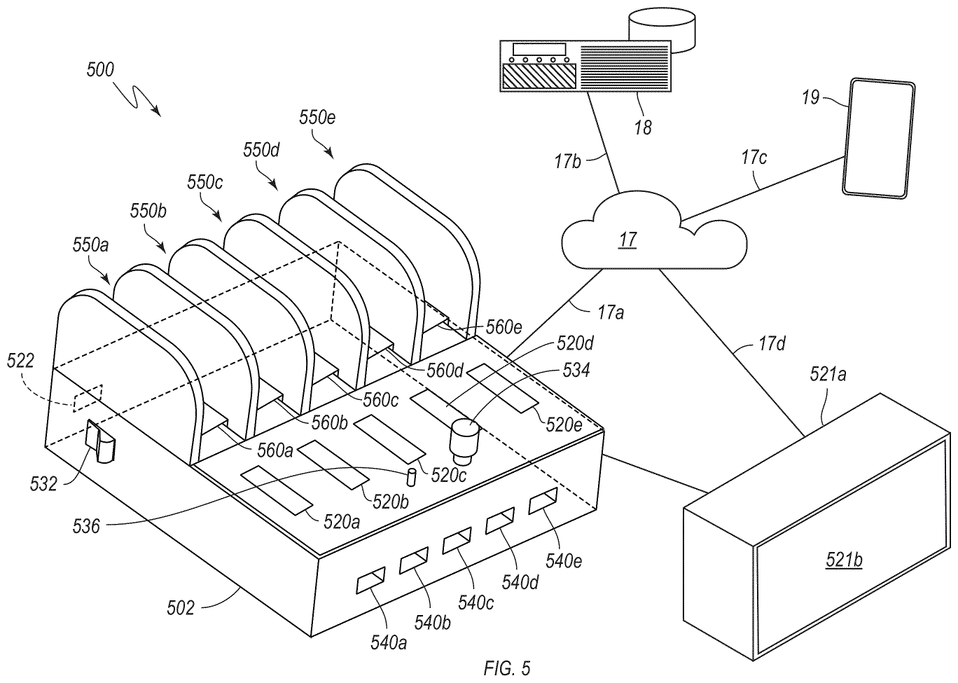

FIG. 5 is a system diagram of a non-use monitoring system (NuMS) 500, similar in at least some respects to the NuMS 100, 300, 400 of FIGS. 2A-4, comprising a base (hereafter, charging station) 502 and a plurality of remote components. The charging station 502 comprises a plurality of displays 520a-520e, an AC interface 522, a power switch 532, and a plurality of ports 540a-540e. Each display 520a-520e is associated to a respective port 540a-540e. Each display 520a-520e is configured to render information, including a label associated to a device of a user, tabulation information, gamification information, etc. (see the labels 330a, 330b and the tabulations 332a, 332b in FIG. 2B). The charging station 502 further comprises a plurality of bays 550a-550e configured to receive a device, such as the device 16, 26 of FIG. 2. Each bay 550a-550e comprises a pressure plate, respectively, 560a-560e. When a device is electrically coupled to a port 540a-540e, the NuMS 500 identifies the device by an association to a label, and causes the particular label to be rendered at the respective display 520a-520e. The NuMS 500 may be configured to accept a user input to select a different label (hence, select a different associated user). User input can be provided at a rotary knob 534 and/or a push button 536. By way of non-limiting example, if a first user (associated to device 16 of FIG. 2B) electrically couples his/her device to a port 540a-540e and the NuMS 500 renders the label for another user, the first user may turn the rotary knob 534 causing the NuMS 500 to sequentially display labels for each other user until the first user's label is rendered at the display 520a-520e. The first user may then press the push button 536 to confirm the selection so that the current period of non-use of the device is attributed to the first user. Alternatively, the first user, when the correct label is rendered, may walk away and the NuMS 500 will adopt the most recently displayed label as associated with the device currently being charged. In instances wherein a user provide input to correct the rendered label, the NuMS 500 may apply a learning algorithm to refine the capability of identifying the device and associating the device to the label and user.

The NuMS 500 may connect, via a two-way communication channel 17a to a cloud computing environment, such as the Internet (hereafter, Internet) 17. The NuMS 500 further comprises a satellite display 521a. In one embodiment, the satellite display unit 521a has a two-way communication channel 17d to the Internet 17, which may enable the satellite display unit 521a to be remotely disposed from the charging station 502. In one embodiment, the satellite display unit 521a may have a direct (“hardwired”) two-way communication channel 517 with the charging station 502, affording a local connection that may be air-gapped from the Internet 17, or permitting the communication channel 17d to serve as a redundant communication channel. The NuMS 500 further comprises a remote computing system 18. The remote computing system 18 may be, e.g., a desktop computer used by a user of the NuMS 500, or a host server providing sponsorship, activities, challenges, etc., for users of the NuMS 500. The NuMS 500 further comprises a portable computing device 19. The portable computing device 19 may be a device, such as the device 16, 26 of FIGS. 2A-3B associated to a user of the NuMS 500, or tablet computer, laptop, computer, etc., used by a user of the NuMS. The remote computing system 18 and the portable computing system 19 may each comprise a display capable of rendering information related to the NuMS 500. By way of example without limitation, a user of the NuMS 500 and the remote computing system 18 or portable computing system 19 may view tabulation or gamification information of the NuMS 500 at a display of the remote computing system 18 or portable computing system 19. An administrator may use the remote computing system 18 or the portable computing system 19 to perform administrative functions, such as to add/delete users or devices, configure a gamification event, broadcast a message to each display associated with the NuMS 500, etc.

The NuMS 500 may comprise a plurality of charging stations 502. In one embodiment having a plurality of charging stations 502, the remote computing system 18 may serve as “host” to receive tabulation data from each charging station 502, and to provide message content for the various displays associated with the NuMS 500. In one embodiment having a plurality of charging stations 502, the charging stations 502 may negotiate, as a cohort, which particular charging station 502 serves as master of the cohort, the master aggregating tabulation across the plurality of charging stations 502 and providing messaging for the various displays associated to the NuMS 500. One example of a NuMS 500 having a plurality of charging stations 502 may be seen in a school classroom wherein multiple charging stations 502 are required to serve all the students. Another example of a NuMS 500 having a plurality of charging stations 502 may be found in a corporate environment wherein individual charging stations 502 may be placed at respective locations convenient to disparate users.

The illustration of five each of the displays 520a-520e, the ports 540a-540e, and the bays 550a-550e in FIG. 5 is for convenience of the disclosure only and not by way of limitation.

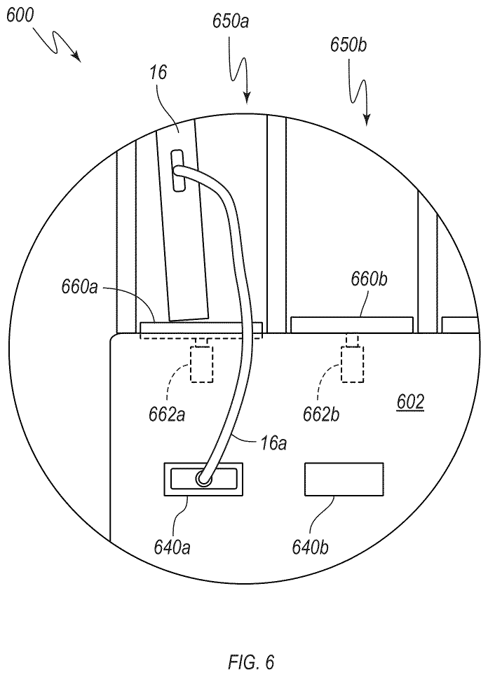

FIG. 6 is a partial front view of a charging station 602 of a non-use monitoring system (NuMS) 600, according to an embodiment of the present disclosure, and illustrating operation of a pressure plate 660a. A first bay 650a and a second bay 650b are shown, the first bay 650a have a device 16 disposed thereat. A device interface cable 16a physically couples, and provides electrical coupling of the device 16 to the charging station 602 via a first port 640a. A second port 640 is shown for reference. Each of the first and second bays 650a, 650b comprises a pressure plate, respectively, 660a, 660b. Each pressure plate 660a, 660b, is coupled to a pressure detector, respectively 662a, 662b. In other words, the charging station 602 comprises a plurality of bays 650a, 650b, and each bay 650a, 650b having a second detector (pressure detector 662), and each bay 650a, 650b disposed and configured to detect whether the personal electronic device 16 is located with a particular, or first distance of the NuMS 600. As shown in FIG. 6, the pressure plate 660a of the first bay 650a is disposed downwardly by the device 16, which downward disposition activates the pressure detector 662a. The pressure detector 662a may be configured to acquire a mass (weight) of the device 16, the mass including the device, a device case, and any add-on feature attached to the device 16 (such as, e.g., a kickstand, etc.) (total mass). The “fingerprint” associated with the device 16 may comprise, in addition to electrical charging characteristics, the mass of the device 16. The mass detected by activation of the pressure detector 662a may assist in identifying the device 16. The NuMS 600 may be configured to discern the physical presence of the device 16 within the bay 650a, which physical presence may be used in gamification to distinguish between non-use with the device 16 in a bay (indicating actual non-use of the device) and possible presence of the device 16 while the device 16 may be in use (such as, e.g., to provide charging without actually participating in non-use). The NuMS 600 may be configured to perform particular tabulation based on known non-use (as established by known mass at the pressure detector 662a) and possible non-use (as established by only electrical coupling of the device 16).

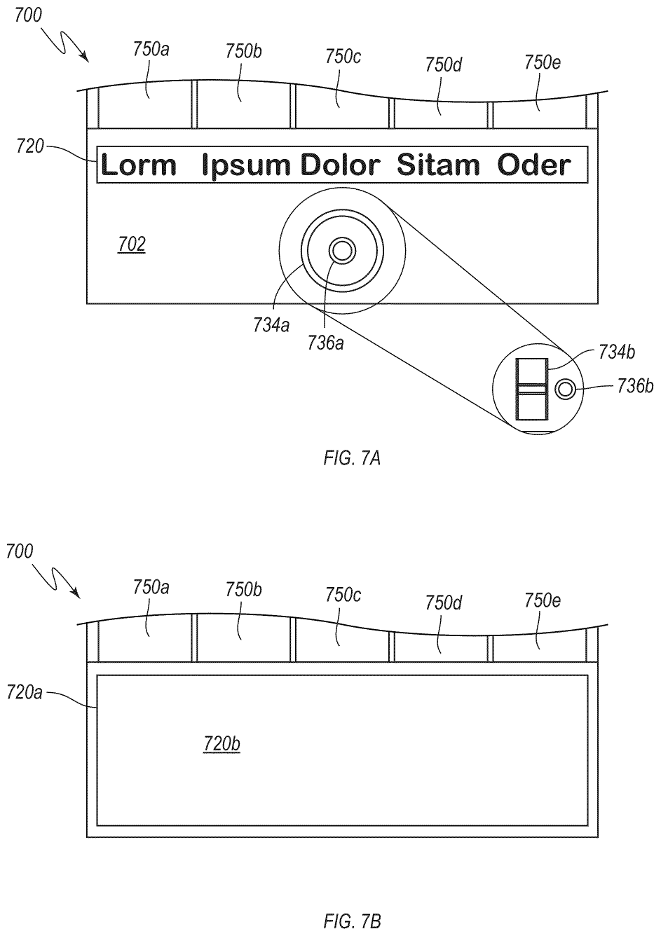

FIGS. 7A and 7B are partial top views of charging stations 702 of a non-use monitoring system (NuMS) 700, according to an embodiment of the present disclosure, and illustrating various user interface methods. A plurality of bays 750a-750e are shown for reference. In FIG. 7A, a strip display 720 is shown proximal to the bays 750a-750e. The strip display 720 may comprise any appropriate display architecture, such as LEDs, LCDs, etc. A rotary knob 734a is shown, having centrally disposed thereat a push button 736a. In one embodiment, the rotary knob 734a may also be a push button. In a callout, a rocker toggle 734b is illustrated in use in place of a rotary knob, with an adjacent push button 736b. In one embodiment, a rocker toggle 734 may be used wherein the rocker toggle 734 may also be depressible, obviating the adjacent push button 736b. In FIG. 7B, a display 720 is shown having a capacitive touchscreen 720b, whereby menus may be displayed and inputs acquired by touching the touchscreen 720b at appropriate locations, and omitting a need for a mechanical switch and/or a mechanical button. These user interface modes are merely samples of embodiments envisioned by the disclosure and are not by way of limitation. While the present disclosure, in particular, the accompanying drawings, have shown a number of display formats, from a plurality of single displays (see the displays 520a-520e of FIG. 5) with each display associated with a port, to a strip display (see the displays 320 and 720 of FIGS. 3A, 3B, and 7A, respectively) potentially serving all the ports, a touch screen (see the display 720b of FIG. 7B), a satellite display unit (see the satellite display unit 521a of FIG. 5), and reference is made to rendering to a display of, e.g., a portable computing system (see the portable computing system 19 of FIG. 5), whereby it will be clear to a person having ordinary skill in the art that the format of a display is not a limiting disclosure. Any suitable display format may be used, provided the display format supports such functionality as rendering a label (a human-readable identifier associated with a particular personal electronic device, or associated to an individual user, a group of users, etc.), additional text, sprites, icons, animations, etc. Said otherwise, a display may be suitable for use if it supports rendering tabulation data and gamification data. The rotary knob 734a and other user interface features (see the rotary knob 534, the push button 536, 736a, 736b, and the touch screen display 720b of, respectively, FIGS. 5, 7A, and 7B) are intended for use with a display to allow a user to confirm that the NuMS 700 has correctly identified a personal electronic device (see the personal electronic device 16, 26 of FIGS. 2B-3B, and 6) coupled to and/or physically present at the NuMS 700; and, when appropriate, to facilitate the user to select a different personal electronic device than the one identified by the NuMS 700 to ensure tabulation of non-use is associated to the proper personal electronic device.

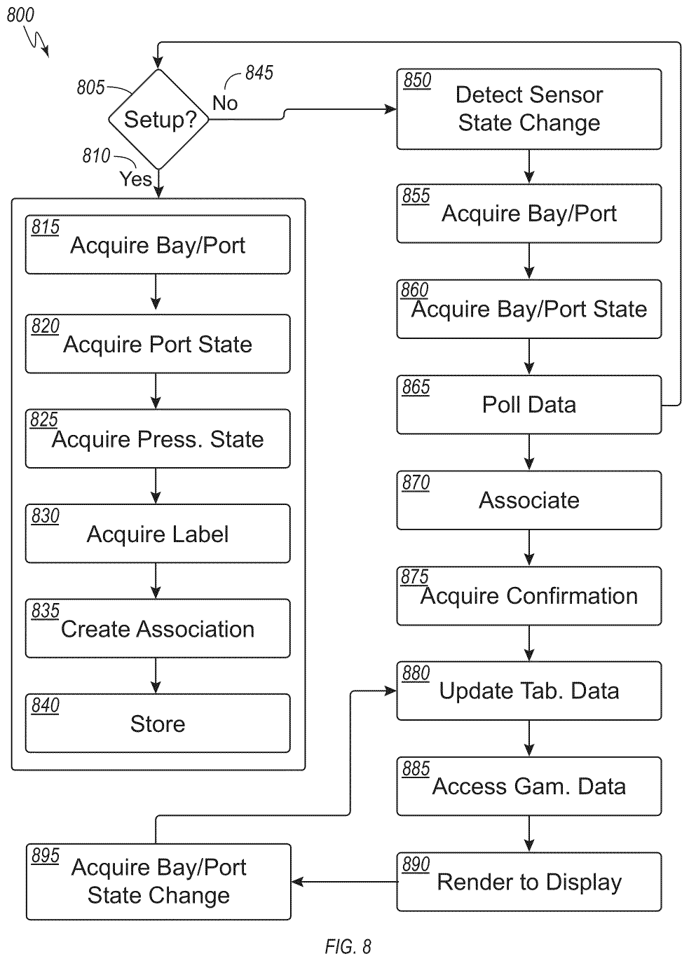

FIG. 8 is a method 800 for operation of non-use monitoring system (NuMS), according to an embodiment of the present disclosure, as may be operative with the NuMS 100, 300, 400, 500, 600, 700 of FIGS. 2A-7B. The NuMS determines 805 if it is necessary to perform setup functions. If “yes” 810, the NuMS acquires 815 a bay and a port to be used for the setup for a device. The NuMS acquires 820 a port state. The port state may be active charging, trickle charging, or device present-not charging. In one embodiment, the port state may include a unique identifier associated to the device, such as MAC ID. The NuMS acquires 825 a pressure state. The pressure state may be present with a particular mass detected, or no mass detected (not present). If no mass is detected, the mass data is omitted for the time being and may be added at a later stage. The NuMS acquires 830 a label for the device. The NuMS may initially designate a general identifier, such as, e.g., Apple iPhone 15 Pro Max. The NuMS may be configured to enable input of alternate label, such as one alphabetically or alphanumerically entered by the user, or by selection of fandom label as described elsewhere herein. The NuMS creates 835 an association of the device electrical characteristics (acquired 825 from the port state) and mass (acquired 825 from the pressure state) to the label. In one embodiment, the NuMS may permit additional associations, such as associating the device to a particular user, to a particular charging station, etc. The NuMS stores 840 the association for later use with tabulation.

If the NuMS determines 805 that, “no,” setup is not currently needed, the NuMS detects a sensor state change. A sensor state change may be a change of mass detected, or change of electrical properties at a port. The NuMS acquires 855 the bay and/or port of the sensor state change(s). The NuMS acquires 860 a bay sensor state change and/or a port sensor state change. The data received includes a total mass (if any) detected at the pressure sensor of the bay, and electrical properties of the electrical coupling (which may also include a device-unique identifier, such as, e.g., a MAC ID) (if any) detected at the port. Using the data received from the bay and port sensor state change(s), the NuMS polls 865 the table wherein is stored identifying data for devices associated with the NuMS. The NuMS may attempt to match both total mass and electrical properties (charging-present), electrical properties only (charging-not present), or total mass only (present-not charging). If there is no match, or no reasonably close match, the NuMS may enter the setup 805. The NuMS associates 870 the current data with the nearest match of data previously stored. Associating 870 to data includes retrieving a label for the identified device to be rendered to a display. The NuMS acquires 875 confirmation that the current device is the identified device. The confirmation includes rendering a message to a display to indicate to a user the label of the identified device. If the current device is the identified device, the user may confirm by an embodiment-specific interaction or by no interaction with the NuMS. If the current device is not the identified device, the user may select from the labels of devices associated with the NuMS to indicate that is the current device. Furthermore, if the current device has no total mass associated with it, and a pressure state change indicates a mass, or the pressure state change indicates a mass other than a total mass associated with the device, the mass detected may be captured to be added (or, respectively, updated) to the characteristics associated with the current device. The NuMS updates 880 the data associated with the label to reflect the associated device is charging, or charging-present (total mass detected). The NuMS may also identify the current device from a detected total mass in the absence of an electrical coupling (present-not charging). The NuMS accesses 885 gamification data. On a first iteration following a device connection, the gamification data is read. On a subsequent iteration, the gamification data may be updated. The NuMS may render 890 at a display tabulation data and/or gamification sprites, message(s), vendor offers, etc. The tabulation data, when displayed, may be updated to reflect the ongoing charging/charging-present state. The NuMS acquires 895 a bay and/or port state change. The bay and/or port state change may indicate a change from charging-present to charging (the total mass is no longer detected), charging to charging-present (the total mass is detected at some point after beginning charging), or not charging. The NuMS again updates 880 the data associated with the label to reflect the detected change of state. The NuMS may, upon updating 880 the data associated with the label, perform tabulation algorithms to maintain a current tabulation, both for the current device and across a pool of devices. The tabulation algorithm may result in gamification rewards or other state changes. The NuMS may again access 885 gamification data, in particular, to update a state of a game and to read gamification data relevant to the updated game state. The NuMS may perform tabulation at timed intervals, as well as in connection with sensor state changes.

FIG. 9 diagrams an architecture of a non-use monitoring system (NuMS) 900, such as the NuMS 100, 300, 400, 500, 600, and 700 of FIGS. 2A-7, respectively, for use in monitoring, tabulating, reporting, and gamifying non-use of personal electronic devices. The NuMS 900 includes a computing system 910. The NuMS 900 comprises a network 905, and the computing system 910. While the description suggests the computing system 910 is a single computing system, the present disclosure anticipates that the computing system 910 may comprise a distributed computing system, etc. The computing system 910 includes a system bus 925, one or more processors 930, an electronic memory 935, an input/output interface (I/O interface) 920, and a network interface 915. The NuMS 900 may include and/or connect with another computing device over the network 905 via the network interface 915.

The one or more processors 930 may include one or more general purpose devices, such as an Intel®, AMD®, or other standard microprocessor. The one or more processors 930 may include a special purpose processing device, such as ASIC, SoC, SiP, FPGA, PAL, PLA, FPLA, PLD, or other customized or programmable device. The one or more processors 930 may perform distributed (e.g., parallel) processing to execute or otherwise implement functionalities of the present embodiments. The one or more processors 930 may run a standard operating system and perform standard operating system functions. It is recognized that any standard operating systems may be used, such as, for example, Microsoft® Windows®, Apple® MacOS®, Disk Operating System (DOS), UNIX, IRJX, Solaris, SunOS, FreeBSD, Linux®, ffiM® OS/2® operating systems, and so forth.

The electronic memory 935 may include static RAM, dynamic RAM, flash memory, one or more flip-flops, ROM, CD-ROM, DVD, disk, tape, or magnetic, optical, or other computer storage medium. The electronic memory 935 may include a plurality of program modules 945-965 and a program data 940. The electronic memory 935 may be local to the computing system 910 or may be remote from the computing system 910 and/or distributed over the network 905.

The program modules 945-965 may include all or portions of other elements of the NuMS 900. The program modules 945-965 may run multiple operations concurrently or in parallel by or on the one or more processors 930. In some embodiments, portions of the disclosed modules, components, and/or facilities are embodied as executable instructions embodied in hardware or in firmware, or stored on a non-transitory, machine-readable storage medium. The instructions may comprise computer program code that, when executed by a processor and/or computing device, cause a computing system to implement certain processing steps, procedures, and/or operations, as disclosed herein. The modules, components, and/or facilities disclosed herein, may be implemented and/or embodied as a driver, a library, an interface, an API, FPGA configuration data, firmware (e.g., stored on an EEPROM), and/or the like. In some embodiments, portions of the modules, components, and/or facilities disclosed herein are embodied as machine components, such as general and/or application-specific devices, including, but not limited to: circuits, integrated circuits, processing components, interface components, hardware controller(s), storage controller(s), programmable hardware, FPGAs, ASICs, and/or the like.

The program data 940 stored on the electronic memory 935 may include data generated by the NuMS 900, such as by the program modules 945-965 or other modules. The stored program data 940 may be organized as one or more databases.

The I/O interface 920 may facilitate interfacing with one or more input devices and/or one or more output devices. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The network interface 915 may facilitate communication with other computing devices and/or networks 905, such as the Internet and/or other computing and/or communications networks. The network interface 915 may be equipped with conventional network connectivity, such as, for example, Ethernet (IEEE 802.3), Token Ring (IEEE 802.5), Fiber Distributed Datalink Interface (FDDI), or Asynchronous Transfer Mode (ATM), etc. Further, the computer may be configured to support a variety of network protocols such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth.

The system bus 925 may facilitate communication and/or interaction between the other components of the NuMS 900, including the one or more processors 930, the electronic memory 935, the I/O interface 920, and the network interface 915.

As noted, the NuMS 900 includes various program modules 945-965 (or engines, elements, or components) (hereafter, “modules”) to implement functionalities of the NuMS 900 and to generate, access, and/or manipulate the program data 940 stored in the electronic memory 935. Each of the various modules 945-965 may comprise machine-readable instructions that may be read and used by the one or more processors 930 to perform various functions of the NuMS 900. The modules 945-965 can include a sensor state module (“SSM”) 945, a tabulation module (“TabM”) 950, an gamification module (“GamM”) 955, a display control module (“DCM”) 960, and other appropriate software modules. There may be more or fewer software modules 945-965 than shown in FIG. 9 and described herein.

The processor 930 is configurable to enable the processor 930 to read and execute computer-executable instructions, such as computer-executable instructions to perform the methods described herein. The computer-executable instructions may be stored in the memory 935, or in another memory accessible to the processor 930. The I/O interface 920 and/or the network interface 915 may enable the processor 930 to communicate with the memory 935 and/or another memory, and to communicate with, for example, a portable computer, such as the portable computer 19 of FIG. 5. The memory 935 may store computer-readable and executable instructions to enable the processor 930 to perform the methods described herein. More particularly, the memory 935 may store instructions to enable the processor 930 to operate the SSM 945 to monitor a plurality of sensors wherein each sensor comprises an electrical detector to detect a charging state change identifiable by a commencement of a current draw, a change in a current draw, an interruption of a current draw at a port with which the individual sensor is associated, the port configured for electrically coupling with a personal electronic device whereby the personal electronic device may be charged. The SSM 945 captures timing elements for each charging state change. Timing elements may be relative or absolute. Relative timing elements may be used to determine a period of electrical coupling and/or physical presence without regard for the real-world local time. Said otherwise, a relative start timing element may be a 0 indicator, with a relative end timing element being a number of discrete time periods counted from that 0, e.g., seconds, etc. Absolute timing elements include a start time, and end time, and may include a measured or calculated duration, all with reference to real-world time. In other words, absolute time includes (or infers) a time of day, day of the week, etc., during which the particular timing elements exist (were recorded). In one embodiment, the SSM 945 is to also monitor a plurality of sensors wherein each sensor comprises a presence detector to detect a presence of a personal electronic device disposed at a particular location (a bay). The presence detector may comprise one or more, or combination of a pressure plate, pressure sensor, a magnet, an optical sensor, or any other appropriate circuit or feature. The presence sensor is configured to detect an introduction to the bay, and the removal therefrom, of a personal electronic device. The presence sensor may be further configured to acquire one or more characteristics of the personal electronic device, such as, e.g., a total weight (weight of the personal electronic device along with a case, screen protector, kickstand, or other add-on), a color, one or more physical dimensions, etc. The SSM 945 captures timing elements of the introduction and removal of the personal electronic device from the bay. The SSM 945 may employ the captured timing elements to calculate a duration of the electrical coupling of the personal electronic device, and a duration of the physical presence of the personal electronic device at the bay. The SSM 945 passes the various timing elements, directly or indirectly, to at least one of the TabM 950 and the GamM 955. The SSM 945, furthermore, may enable the processor 930 to acquire one or more physical characteristics detected by a presence sensor. The one or more physical characteristics may enable or assist the processor 930 in associating the personal electronic device to a label, the label representing an user of the NuMS. Similarly, the one or more physical characteristics may enable or assist the processor 930 in determining that the personal electronic device is not associated with a label, thus enabling the processor 930 to execute instructions to perform a setup where by a new association of personal electronic devices to a label or a user is performed, and stored in the memory 935.

The memory 935 may store instructions to enable the processor 930 to operate the tabulation module (TabM) 950 to tabulate non-use of a personal electronic device, including non-use of an individual personal electronic device of a plurality of personal electronic devices. The TabM 950 receives from the SSM 945 timing elements indicative of an electrical coupling of the personal electronic device at a port of the NuMS, the electrical coupling suggestive of non-use of the personal electronic device. In one embodiment, the TabM 950 receives timing elements indicative of a physical presence of the personal electronic device at a bay of the NuMS. The timing elements received by the TabM 950 may comprise one or more of a start and end time of a particular detection, or a duration of the particular detection, or both. The TabM 950 tabulates, or calculates, or enable the processor 930 to tabulate or calculate a duration of an electrical coupling suggestive of non-use of the personal electronic device while charging, a duration of physical presence of the personal electronic device at the bay. The TabM 950 may further access the memory to retrieve one or more mathematical equations, variables, constants, etc. (collectively, algorithms) for scoring non-use of the personal electronic device. A period of non-use of a personal electronic device can be scored using the algorithms. The algorithms may be configurable to provide for “weighting” of a period of non-use of the personal electronic device. The weighting can be configured based on a time of day for a non-use period, day of week, duration of the non-use period, whether the non-use period was suggested by an electrical coupling only, or more definitively established through detection of physical presence of the personal electronic device at a bay of the NuMS. Some algorithms may be applied to discrete personal electronic devices individually. An algorithm may be used to consolidate (or aggregate) periods of non-use across multiple personal electronic devices, such as a smart phone and a tablet computer associated to the same individual. An algorithm may be used to consolidate (or aggregate) periods of non-use across a plurality of personal electronic devices representing a plurality of individuals, such as a family, a class of a school, a work cohort, etc. An algorithm may be used to consolidate (or aggregate) periods of non-use occurring during a discrete period, such as across a calendar period, or during a family vacation, a school field trip, a contest period, etc. The TabM 950 may store the results of tabulation in a data system (e.g., a data base). The data system may be located at memory 935, and may be local to the NuMS, local to a NuMS server, local to a NuMS master of belonging to a cohort of NuMS, etc. The data system may be stored remotely, including stored in a cloud computing environment. The TabM 950 may send tabulation data to the GamM 955 and/or the DCM 965, either upon a triggering event or at discrete intervals, or both.

The memory 935 may store instructions to enable the processor 930 to operate the gamification module (GamM) 955 to create, edit, update, and otherwise perform gamification functions based on tabulation provided by the TabM 950 or retrieved from the memory 935. Gamification may provide incentives to reduce use of a personal electronic device. Gamification may include creating a competition between users of the NuMS, or between discrete user groups. Gamification may further include providing rewards for reaching a discrete threshold of non-use. For example without limitation, gamification may take the form of a threshold tabulation of non-use may be set for an individual user (or for a plurality of individual users), and, upon reaching that threshold, a badge is awarded, a game is unlocked on the personal electronic device for a period of play, access to cloud-based game may be unlocked for a period of play, a pre-selected video may be unlocked for viewing, etc. By way of further example without limitation, a NuMS administrator for a family NuMS may set of goal of a certain amount of non-use of personal electronic devices as a collective (an aggregate across all family members) in a defined calendar period (or by a particular date), and, upon achievement, the family engages in a desirable activity, such as, e.g., playing a multiplayer game together on their individual personal electronic devices, taking a trip to a theme park, having dinner at a favorite restaurant, etc. In a broader setting, gamification may include a school class being rewarded upon achieving a non-use goal across a school term with game play, a field trip, etc., A corporate setting, likewise, may employ gamification by providing tangible or intangible rewards, such as added time off, a “casual day,” brand merchandise, event tickets, etc. A NuMS administrative user may enroll the NuMS into a commercial program whereby commercial provisioning of advertising, rewards, motivational messages, etc., may be incorporated into the gamification. The GamM 955 may enable the processor 930 to provide prompts to, and accept input from a user to establish a gamification program. The GamM 955 may enable the processor 930 to present a menu system at a display whereby a user makes selections which are, in turn, used to configure a gamification entry, the gamification entry enrolled to the GamM 955 and stored in the memory 935. The menu system may allow setting a non-use goal for all users of the NuMS, or to set discrete non-use goals for a subset of users or individual users. By way of example, a parent administering the NuMS may review tabulation (compiled by operation of the TabM 950) of non-use for each family member, and may set a goal to increase the total time of non-use on weekday evenings for school-age children in the family. The parent administrator may observe a trend by one child to not have that child's personal electronic device coupled/disposed at the NuMS during nighttime hours, and may set a goal to increase the number of days/amount of time, that child leaves the personal electronic device coupled to/disposed at the NuMS. A corporate administrator may subscribe to commercial provisioning whereby corporate NuMS users are incentivized to use the office NuMS during business hours with a reward of discounts at local businesses, event tickets, merchandise, etc. By way of example, a company may deploy a NuMS to its offices and subscribe to commercial provisioning underwritten by the group health insurance provider whereby employees are incentivized to increase non-use during work hours, with potential rewards, such as, e.g., a discounted gym membership, etc. related to life style, healthy practices, etc.

The GamM 955 captures aspects of each gamification program, associates internal identifiers whereby discrete personal electronic devices may be associated to one or more gamification programs, polls the tabulation data (generated by the TabM 950) in the memory 935, generates or pulls messaging to be presented at one or more displays of (or accessible to) the NuMS, the messages presenting a visual representation of progress toward a goal, a competitive standing, a motivational message, a reminder regarding the gamification program, a lifestyle message related to reducing use of personal electronic devices, etc. The GamM 955 may further enable the processor 930 to notify an administrator (or a fulfillment entity) of completion of a goal, whereby an assigned reward is delivered. In some gamification programs, the reward may be intangible, but others may include tangible, physical rewards. The GamM 955 may cause to be delivered to the DCM 960 messages to be rendered at a display. In one embodiment, the GamM 955 stores gamification data at a memory allocated exclusively to the GamM 955. In one embodiment, the GamM 955 stores gamification data at the memory 935. The GamM 955 may update the stored gamification data upon a triggering event, or at discrete intervals, or both.

The memory 935 may store instructions to enable the processor 930 to operate the display control module (DCM) 960 to enable delivery of messages to be rendered at one or more displays of, or associated with, the NuMS. The DCM 960 may receive a signal from the TabM 950, or from the GamM 955, or from another module of NuMS indicating a particular message be retrieved, generated, etc., and delivered to a display. The signal may identify a message, may identify a message label, may include content to be incorporated in or used as the message, and may further designate a particular display (or plurality of displays) to render the message, a time for rendering the message, etc. The DCM 960 may be configured to initially receive message data to be stored at the DCM 960 or at the memory 935, and may store the message data for future use. The message data may comprise meta data, the meta data providing use cases and other information for deploying the message. The meta data may indicate display format, resolution, color space, etc. The message data may comprise a body of information comprising or substantially comprising the message to be rendered. Both the TabM 950 and the GamM 955 may identify a threshold or triggering event corresponding to a message related to acknowledging progress, providing motivation, generating and delivering an intangible reward, notifying an administrator (or fulfillment entity). The DCM 960, based on a signal received from the TabM 950 or the GamM 955, may retrieve a particular message from the memory 935 and cause the message to be delivered to one or more designated displays, or all displays associated with the NuMS. The DCM 960 may, at regular intervals, generate a message to be rendered for the purpose of motivation, encouragement, reinforcement, etc., to increase non-use (decrease use) of the personal electronic device. The message data stored by (and accessed by) the DCM 960 may comprise video, audio, textual, graphical, data capable of being rendered to a display (including to a speaker).

As will be clear to a person having ordinary skill in the art, the functions of the above-described engines 945-965 may be performed by one or more software engines, modules, etc. A function described in conjunction with a particular engine 945-965 may be performed by another engine or software instruction without detracting from the present disclosure. A software engine, module, module, or component may include any type of computer instruction or computer executable code located within a memory device and/or computer-readable storage medium, as is well-known in the art.

### Examples

Some examples of embodiments of the present disclosure are provided below.
Example 1. A non-use monitoring system for a personal electronic device, comprising: an electrical charging circuit to couple to a personal electronic device; a first detector to detect an electrical coupling of the personal electronic device to the electrical charging circuit and to generate a signal associating to the personal electronic device at least one of a time of coupling and a duration of coupling of the personal electronic device to the electrical charging circuit; a second detector to detect whether the personal electronic device is located within a first distance of the non-use monitoring system; and a connection tabulator to generate an aggregation of the at least one of the time of coupling and the duration of coupling for multiple instances of both coupling of the device to the electrical charging circuit and detection that the personal electronic device is located within the first distance of the non-use monitoring system, the connection tabulator further to cause the aggregation to be provided to a display.
Example 2. The non-use monitoring system of Example 1, wherein the first detector comprises a shunt resistor current sensor.
Example 3. The non-use monitoring system of Example 1, wherein the second detector comprises a pressure plate upon which the personal electronic device may be placed.
Example 4. The non-use monitoring system of Example 1, wherein the first detector is configured to detect current draw by the personal electronic device.
Example 5. The non-use monitoring system of Example 4, wherein the first detector is configured to detect current draw even when the personal electronic device is in a trickle charge mode by detecting the presence of current spikes within a period of time.
Example 6. The non-use monitoring system of Example 1, further comprising: a base to house the electrical charging circuit, the first detector, the second detector, and the connection tabulator; and a port to receive the personal electronic device, wherein the port is defined by or supported by the base.
Example 7. The non-use monitoring system of Example 1, further comprising an identity indicator to indicate an identity of, or identity of an individual associated with, the personal electronic device.
Example 8. The non-use monitoring system of Example 1, wherein the connection tabulator is configured to maintain a plurality of aggregations each associated with a different personal electronic device of a plurality of personal electronic devices.
Example 9. The non-use monitoring system of Example 1, wherein the system is configured to query, across the port, the personal electronic device for a unique identifier of the personal electronic device, and wherein the non-use monitoring system associates the unique identifier to one of the identity of the personal electronic device and the identity of the individual associated with the personal electronic device.
Example 10. A system for monitoring non-use of personal electronic devices, comprising: an electrical charging circuit to couple to one or more personal electronic devices; an electrical coupling detector to detect an electrical coupling of a given personal electronic device of the one or more personal electronic devices to the electrical charging circuit and to generate a signal associating the given personal electronic device to a duration of the electrical coupling to the electrical charging circuit; a presence detector to detect a presence of the given personal electronic device deposited at the system; and a connection tabulator circuit to generate an aggregate duration of coupling of the given personal electronic device to the electrical charging circuit and to cause the aggregate duration to be provided for rendering at a display, wherein the aggregate duration comprises an aggregation of durations of a plurality of electrical couplings of the given personal electronic device to the electrical charging circuit that the presence detector also detects the presence of the given personal electronic device deposited at the system.
Example 11. The system of Example 10, wherein the electrical coupling detector generates a signal associating the given personal electronic device to a duration of the electrical coupling to the electrical charging circuit by: signaling a start time that the electrical coupling is established; and signaling an end time that the electrical coupling is broken.
Example 12. The system of Example 10, wherein the electrical coupling detector generates the signal associating the given personal electronic device to the duration of the electrical coupling to the electrical charging circuit by providing the signal throughout the duration.
Example 13. The system of Example 12, wherein the electrical coupling detector generates the signal one of: (i) intermittently throughout the duration; or (ii) constantly throughout the duration.
Example 14. The system of Example 10, wherein the presence detector generates one of: (i) a signal representing detection of the presence of the personal electronic device, or (ii) a first signal representing commencement of the presence, and a second signal representing cessation of the presence of the personal electronic device.

While various aspects and embodiments have been disclosed herein, other aspects and embodiments are contemplated. The various aspects and embodiment disclosed herein are for purposes of illustration and are not intended to be limiting. It will be apparent to those having skill in the art that many changes may be made to the details of the above-described embodiments without departing from the underlying principles of the disclosure. The scope of the present disclosure should, therefore, be determined only by the following claims.

1. A non-use monitoring system for a personal electronic device, comprising:
an electrical charging circuit to couple to a personal electronic device;
a first detector to detect an electrical coupling of the personal electronic device to the electrical charging circuit and to generate a signal associating to the personal electronic device at least one of a time of coupling and a duration of coupling of the personal electronic device to the electrical charging circuit;
a second detector to detect whether the personal electronic device is located within a first distance of the non-use monitoring system; and
a connection tabulator to generate an aggregation of the at least one of the time of coupling and the duration of coupling for multiple instances of both coupling of the device to the electrical charging circuit and detection that the personal electronic device is located within the first distance of the non-use monitoring system, the connection tabulator further to cause the aggregation to be provided to a display.

2. The non-use monitoring system of claim 1, wherein the first detector comprises a shunt resistor current sensor.

3. The non-use monitoring system of claim 1, wherein the second detector comprises a pressure plate upon which the personal electronic device may be placed.

4. The non-use monitoring system of claim 1, wherein the first detector is configured to detect current draw by the personal electronic device.

5. The non-use monitoring system of claim 4, wherein the first detector is configured to detect current draw even when the personal electronic device is in a trickle charge mode by detecting the presence of current spikes within a period of time.

6. The non-use monitoring system of claim 1, further comprising:
a base to house the electrical charging circuit, the first detector, the second detector, and the connection tabulator; and
a port to receive the personal electronic device,
wherein the port is defined by or supported by the base.

7. The non-use monitoring system of claim 1, further comprising an identity indicator to indicate an identity of, or identity of an individual associated with, the personal electronic device.

8. The non-use monitoring system of claim 1, wherein the connection tabulator is configured to maintain a plurality of aggregations each associated with a different personal electronic device of a plurality of personal electronic devices.

9. The non-use monitoring system of claim 1, wherein the system is configured to query, across the port, the personal electronic device for a unique identifier of the personal electronic device, and wherein the non-use monitoring system associates the unique identifier to one of the identity of the personal electronic device and the identity of the individual associated with the personal electronic device.

10. A system for monitoring non-use of personal electronic devices, comprising:
an electrical charging circuit to couple to one or more personal electronic devices;
an electrical coupling detector to detect an electrical coupling of a given personal electronic device of the one or more personal electronic devices to the electrical charging circuit and to generate a signal associating the given personal electronic device to a duration of the electrical coupling to the electrical charging circuit;
a presence detector to detect a presence of the given personal electronic device deposited at the system; and
a connection tabulator circuit to generate an aggregate duration of coupling of the given personal electronic device to the electrical charging circuit and to cause the aggregate duration to be provided for rendering at a display, wherein the aggregate duration comprises an aggregation of durations of a plurality of electrical couplings of the given personal electronic device to the electrical charging circuit that the presence detector also detects the presence of the given personal electronic device deposited at the system.

11. The system of claim 10, wherein the electrical coupling detector generates a signal associating the given personal electronic device to a duration of the electrical coupling to the electrical charging circuit by:
signaling a start time that the electrical coupling is established; and
signaling an end time that the electrical coupling is broken.

12. The system of claim 10, wherein the electrical coupling detector generates the signal associating the given personal electronic device to the duration of the electrical coupling to the electrical charging circuit by providing the signal throughout the duration.

13. The system of claim 12, wherein the electrical coupling detector generates the signal one of: (i) intermittently throughout the duration; or (ii) constantly throughout the duration.

14. The system of claim 11, wherein the presence detector generates one of: (i) a signal representing detection of the presence of the personal electronic device, or (ii) a first signal representing commencement of the presence, and a second signal representing cessation of the presence of the personal electronic device.
